(19) United States
(12) Patent Application Publication
(10) Pub. No.: US 2018/0144738 A1
(43) Pub. Date: May 24, 2018

(54) SELECTING OUTPUT FROM CANDIDATE UTTERANCES IN CONVERSATIONAL INTERFACES FOR A VIRTUAL AGENT BASED UPON A PRIORITY FACTOR

(71) Applicant: IPsoft Incorporated, New York, NY (US)

(72) Inventors: Ugan YASAVUR, Jersey City, NJ (US); Reza Amini, Secaucus, NJ (US); Jorge Travieso, New York, NY (US); Chetan Dube, New York, NY (US)

(21) Appl. No.: 15/493,512

(22) Filed: Apr. 21, 2017

Related U.S. Application Data
(60) Provisional application No. 62/425,847, filed on Nov. 23, 2016.

(51) Int. Cl. G10L 13/04; G10L 25/51; G10L 15/18; G10L 15/19

(52) U.S. Cl. CPC G10L 13/043; G10L 25/51; G10L 15/19; G10L 15/1822; G10L 15/1815

(57) ABSTRACT

There is provided a method for automatically determining an output utterance for a virtual agent based on output of two or more conversational interfaces. A candidate output utterance from each of the two or more conversational interfaces can be received, and one candidate output utterance from all received candidate outputs can be selected based on a predetermined priority factor. The selected utterance can be output by the virtual agent.

### CROSS REFERENCE TO RELATED APPLICATIONS

This application claims priority of and benefit to U.S. provisional patent application No. 62/425,847, filed on Nov. 23, 2016, the entire contents of which are incorporated herein by reference in their entirety.

### FIELD OF THE INVENTION

The invention relates generally to virtual agents' interactions with users. In particular, the invention relates to methods for a virtual agent to interact with a user using multiple structured and/or unstructured dialogue types.

### BACKGROUND OF THE INVENTION

Current cognitive computing systems can include virtual agents. The virtual agents can interact with users via natural language dialogues. Current virtual agents typically include dialogue management systems that include structured dialogue management strategies, for example, goal drive systems and/or plan-based systems. One difficulty with current systems is that there are many different styles of dialogues and typical current dialogue systems can only handle structured dialogues. For example, current systems typically handle dialogues that are designed for information collection, and can have difficulty handling conversations that involve contextual question answering and/or social chit chat.

Another difficulty with current systems is that they do not handle context switching mid-dialogue.

Current dialogue management systems can involve determining similarity between utterances. For example, current dialogue management systems may try to determine how similar a user utterance is to its expected utterance. Current methods for determining similarity between utterances can involve comparing paraphrases. These current methods can have less accuracy when the context of dialogue is switched. Therefore, it can be desirable to determine similarity between utterances with a high level of accuracy, even when context is switched.

### SUMMARY OF THE INVENTION

Some advantages of the technology can include an ability to handle unstructured dialogue and/or multiple dialogue types. Another advantage of the invention is the ability to switch context mid-dialogue. Another advantage of the invention is accuracy when determining similarity between utterances. Another advantage of the invention is the ability to manage heterogonous systems where there are multiple response providers for user inputs.

Some advantages of the invention can involve an ability to provide a response for utterances of a slot, goal, dialogue act and/or other utterances that may not have a match with historical conversations.

In one aspect, the invention involves a computerized method for generating an output utterance for a virtual agent's conversation with a user. The method can involve receiving a natural language user utterance from the user. The method can also involve determining a topic of the natural language user utterance. The method can also involve identifying all dialogues from a plurality of dialogues having a topic that matches the topic of the natural language user utterance, each dialogue having a plurality of utterances. The method can also involve determining an anchor utterance of each identified dialogue by selecting one utterance of the plurality of utterances in each identified dialogue having a first similarity score with the natural language user utterance that is greater than a predetermined similarity threshold. The method can also involve determining a second similarity score for each identified dialogue between a previous natural language user utterance of the conversation and an utterance previous to the anchor utterance in each identified dialogue. The method can also involve for each identified dialogue, assigning a first weight to the first similarity score to create a first weighted similarity score, assigning a second weight to the second similarity score to create a second weighted similarity score. The method can also involve for each identified dialogue, determining a summed similarity score by summing the respective first weighted similarity score and the respective second weighted similarity score. The method can also involve determining the output utterance by selecting one dialogue from the identified dialogues having a highest value of the summed similarity score, and setting the output utterance to an utterance that is subsequent to the anchor utterance in the selected one dialogue. The method can also involve outputting the output utterance to the user.

In some embodiments, the plurality of utterances is an ordered list of utterances and determining the anchor utterance further involves determining a temporary similarity score between the natural language user utterance and each utterance in an order specified by the ordered list until the temporary similarity score is greater than the predetermined threshold, and setting the first similarity score to the temporary similarity score, and setting the anchor utterance to the utterance having the temporary similarity score that is greater than the predetermined threshold.

In some embodiments, the output utterance is natural language. In some embodiments, determining the first similarity score further comprises, for each of the plurality of utterances compared against the user utterance, determining one or more cardinalities between one or more respective intersections of the current utterance of the plurality of utterances and the user utterance, and determining the first similarity score based on a weighted sum of the one or more cardinalities.

In some embodiments, determining the second similarity score also involves determining one or more cardinalities between one or more respective intersections of the previous user utterance and the utterance previous to the anchor utterance, and determining the second similarity score based on a weighted sum of the one or more cardinalities.

In some embodiments, the predetermined similarity threshold is input by a user or based on a topic of conversation.

In another aspect, the invention involves a computerized method for a virtual agent to determine a similarity between a first utterance and a second utterance. The method can involve receiving the first utterance and the second utterance. The method can involve determining one or more cardinalities between one or more respective intersections of the first utterance and the second utterance, and determining the similarity score based on a weighted sum of the one or more cardinalities.

In some embodiments, the first utterance is an utterance of a user. In some embodiments, the second utterance is a predetermined utterance. In some embodiments, the first utterance, the second utterance, or both are natural language. In some embodiments, the first utterance, the second utterance or both are a sentence or a paraphrase.

In some embodiments, determining the one or more cardinalities also involves determining a first cardinality of a first intersection of the first utterance and the second utterance, determining a second cardinality of a second intersection of trigrams of the first utterance and trigrams of the second utterance, determining a third cardinality of a third intersection of bigrams of the first utterance and bigrams of the second utterance, determining a fourth cardinality of a fourth intersection of word lemmas of the first utterance and word lemmas of the second utterance, determining a fifth cardinality of a fifth intersection of word stems of the first utterance and word stems of the second utterance, determining a sixth cardinality of a sixth intersection of skip grams of the first utterance and skip grams of the second utterance, determining a seventh cardinality of a seventh intersection of word2vec of the first utterance and word2vec of the second utterance, determining an eighth cardinality of an eighth intersection of antonyms of the first utterance and antonyms of the second utterance and determine the similarity score based on a weighted sum of the first cardinality, the second cardinality, the third cardinality, the fourth cardinality, the fifth cardinality, the sixth cardinality, the seventh cardinality and the eighth cardinality, wherein the weights are predetermined weights.

In some embodiments, the second utterance is an utterance of a dialogue that the virtual agent seeks to use as an output response to a user. In some embodiments, the first utterance is a frequently asked question, the second utterance is a response to the frequently asked question.

In another aspect, the invention involves a computerized method for automatically determining an output utterance for a virtual agent based on output of two or more conversational interfaces. The invention involves receiving a candidate output utterance from each of the two or more conversational interfaces, selecting one candidate output utterance from all received candidate outputs based on a predetermined priority factor, and outputting the one candidate output utterance as the output utterance for the virtual agent.

In some embodiments, the two or more conversational interfaces are any combination of dialogue management systems or question answering systems.

In some embodiments, the method also involves receiving a corresponding confidence factor with each candidate output utterance from each of the two or more conversational interfaces, and wherein selecting the one candidate output utterance is further based on the corresponding confidence factor, wherein the confidence factor indicates a confidence of the respective conversational interface in its produced candidate output utterance.

In some embodiments, the predetermined priority factor is based on the confidence factor, a type of the respective conversational interface, input by a user, based on the content of the utterance, or any combination thereof.

In some embodiments, selecting one candidate output utterance is further based on determining one conversational interface of the two or more conversational interfaces that output a previous output utterance and, if the one conversational interface retains context of dialogues, then the corresponding candidate output utterance of the one conversational interface is set as the one candidate output utterance.

In some embodiments, each of the two or more conversations interfaces processes a different conversation type. In some embodiments, the candidate output utterance, the output utterance, or both are natural language.

In another aspect, the invention involves a computerized method for generating an output utterance for a virtual agent's conversation with a user. The method can involve receiving a natural language user utterance. The method also can involve identifying at least one of a goal of the user, a piece of information needed to satisfy a goal, or a dialogue act from the user utterance. The method can also involve identifying all dialogues of a plurality of dialogues that match the identified at least one goal, the piece of information or the dialogue act. The method can also involve selecting a dialogue of the identified dialogues having a highest number of matching utterances with the identified at least one goal, the piece of information or the dialogue act of the user utterance. The method can also involve outputting the output utterance to the user based on the selected dialogue.

In some embodiments, the method involves, if more than one dialogue is identified as having a highest number of matches with the identified at least one goal, the piece of information or the dialogue act of the user utterance, selecting one of the more than one dialogues. In some embodiments, the output utterance is natural language.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a flow chart of a method for generating an output utterance for a virtual agent's conversation with a user, according to an illustrative embodiment of the invention;

FIG. 2 is a flow chart of a method for a virtual agent to determine a similarity between a first utterance and a second utterance, according to an illustrative embodiment of the invention;

FIG. 3 is a flow chart of a method for determining an output utterance for a virtual agent based on output of two or more conversational interfaces, according to an illustrative embodiment of the invention;

FIG. 4 is a flow chart of a method for generating an output utterance for a virtual agent's conversation with a user, according to an illustrative embodiment of the invention;

FIG. 5 is a flow chart of a method for generating an output utterance for a virtual agent's conversation with a user, according to an illustrative embodiment of the invention; and

FIG. 6 is a diagram of a system for a virtual agent, according to an illustrative embodiment of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In general, a user can interact with a virtual agent. The interaction can include the user having a dialogue with the virtual agent. The dialogue can include utterances (e.g., any number of spoken words, statements and/or vocal sounds). The virtual agent can include a system to manage the dialogue.

The system can drive the dialogue to, for example, help a user to reach goals and/or represent a state of the conversation. When the system receives an utterance, the system can determine a type of the utterance and determine an action for the virtual agent to take.

In general, the system can include one or more conversational interfaces. Each conversational interface can handle utterances in a different manner, and some of the conversational interfaces can handle different utterance types. For example, a first conversational interface can handle an utterance that is a question and a second conversational interface can handle an utterance that is stated goal. In another example, a first conversational interface and a second conversational interface can both handle an utterance that is a stated goal, each returning unique output. In the case where multiple conversational interfaces can handle the utterance (e.g., can produce an output to the user), arbitration based on a predetermined priority can occur, such that only one output is presented.

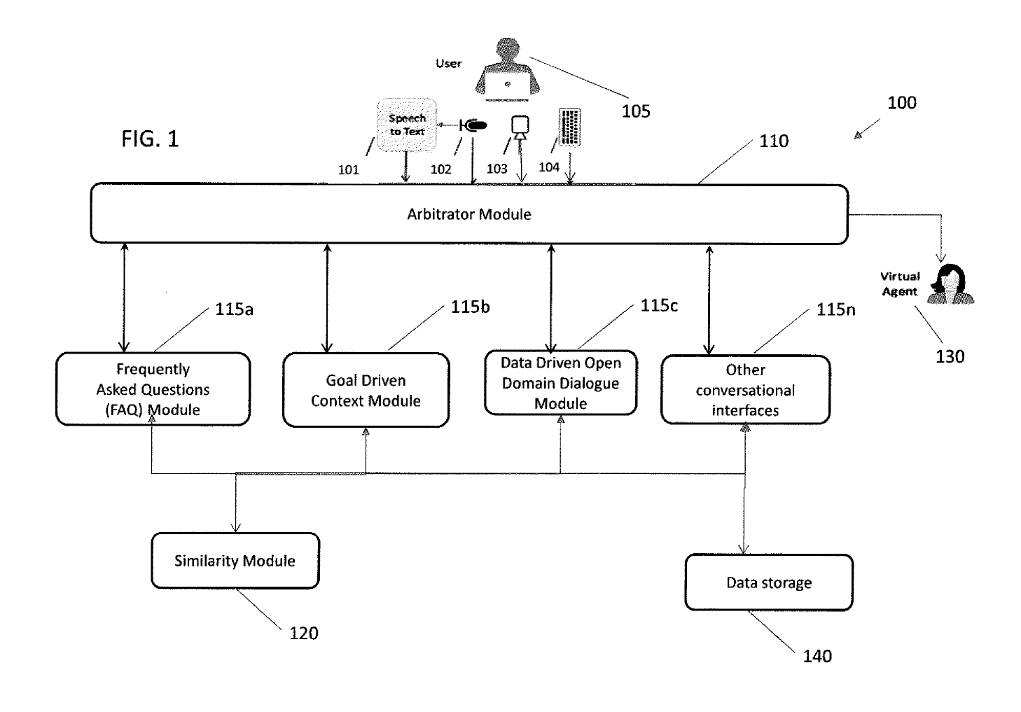

FIG. 1 is a diagram of system 100 architecture for a virtual agent having multiple conversational interfaces, according to an illustrative embodiment of the invention.

The system 100 includes an arbitrator module 110, the multiple conversational interfaces 115a, 115b, 115c, . . . , 115n, generally 115, a similarity module 120, and a data storage 140. The multiple conversational interfaces include a frequently asked questions module 115a, a goal driven context 115b, a data driven open domain dialogue module 115c, and other conversational interfaces 115n. The other conversational interfaces 115n can be any conversational interface as is known in the art (e.g., dialogue management systems and/or question answer systems).

The arbitration module 110 can communicate with a user 105, with the multiple conversational interfaces 115, and an output avatar for the virtual agent 130. The multiple conversational interfaces 115 can communicate with a similarity module 120 and the data storage 140. The data storage can include one or more dialogues, thresholds and/or other data needed by the multiple conversational interfaces 115 as described in further detail below. In various embodiments, the virtual agent output is audio via a microphone, text on a computer screen, or any combination thereof.

In some embodiments, there is one arbitration module and three dialogue systems. The first dialogue system can emulate interactions that are observed in historical conversations by, for example, using semantic similarity algorithms, the first dialogue type can be open domain dialogues such as small talk or chitchat. The second dialogue system can be a data-driven task based dialogue system (e.g., goal-driven context module) which can handle use-cases where there are available tasks but a type of the task does not match stored goal oriented dialogues and also where there is a need for learning online from new conversations. The third dialogue system can be a question answering system which can handle one turn dialogues such as frequently asked questions.

During operation, a user utterance can be received. The user utterance can be received via a speech to text device 101, a microphone 102, a video camera 103 and/or a keyboard 104. The user utterances can also be received via a tablet or smart phone interface.

The arbitrator module 110 can transmit the user utterance to one or more of the multiple conversational interfaces 115. Each of the multiple conversational interfaces 115 can output a candidate output utterance. Each candidate output utterance can include a confidence level in its response. In some embodiments, if a particular conversational interface of the multiple conversations interfaces 115 cannot provide a response to the user utterance (e.g., the user utterance is a goal and the particular conversational interface only handles frequently asked questions), then the particular conversational interface can refrain from outputting a response, or output a response having a zero confidence factor.

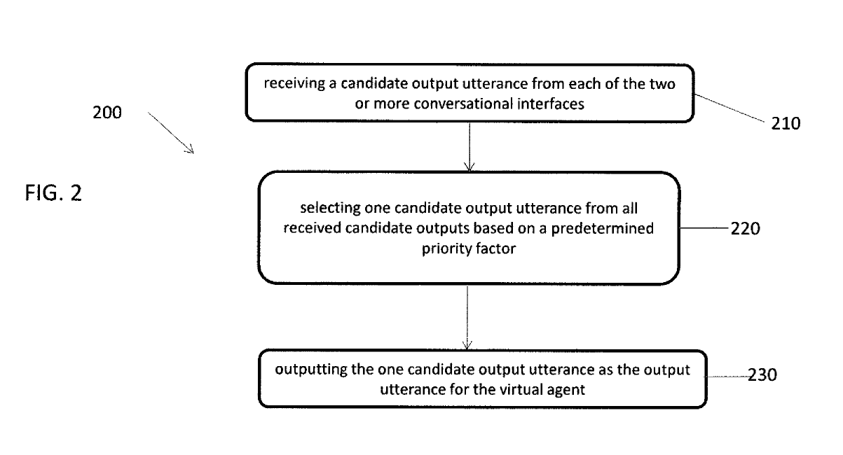

The arbitrator module 110 can determine which candidate output utterance to transmit to the virtual agent 130. The arbitrator module 110 can determine which candidate output utterance to transmit to the virtual agent 130 by assigning a priority to the multiple conversational interfaces 115. The priority can be based on a predetermined priority, the particular conversational interface whose output was last used by the virtual agent 130 and/or whether a conversational interface retains context. The arbitrator module 110 can determine which candidate output to transmit to the virtual agent avatar 130, as described in further detail with respect to FIG. 2 below.

FIG. 2 is a flow chart of a method 200 for determining an output utterance for a virtual agent based on output of two or more conversational interfaces (e.g., multiple conversational interfaces as described above in FIG. 1), according to an illustrative embodiment of the invention.

The method can involve receiving (e.g., by the arbitration module 110 as described above in FIG. 1) a candidate output utterance from each of the two or more conversational interfaces (Step 210).

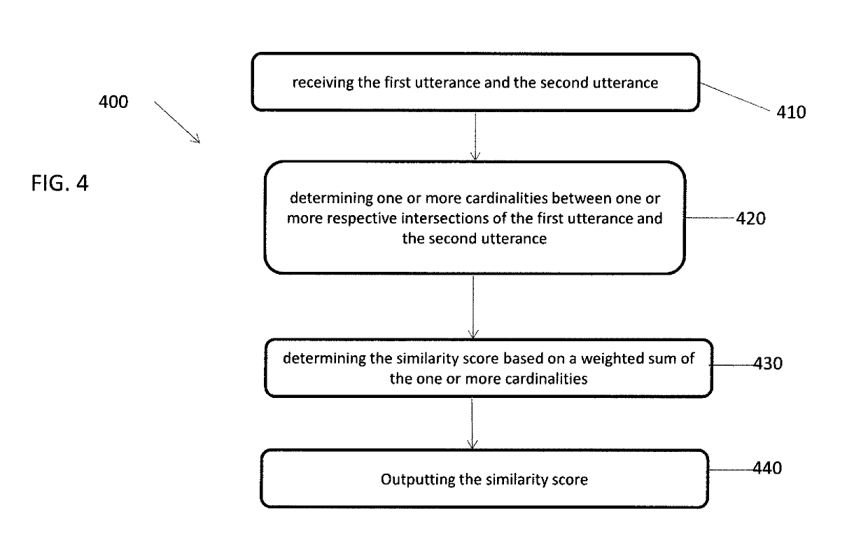

In some embodiments, the candidate output includes a confidence factor. The confidence factor can indicate a confidence of the respective conversational interface in its produced candidate output utterance. For conversational interfaces that use a similarity (e.g., the similarity score as described below in FIG. 4) to determine an output utterance, in some embodiments, the confidence factor can be the similarity score. In various embodiments, the confidence factor can be based on conditions under which a particular interface returns input. For example, for a conversational interface that responds under all conditions (e.g., a chit chat conversational interface), the confidence can be set to a low value (e.g., under 0.4). In some embodiments, the confidence factor is based on constrained conditions that return a discreet confidence value (e.g., low below 0.4, medium between 0.4 and 0.6, high above 0.6).

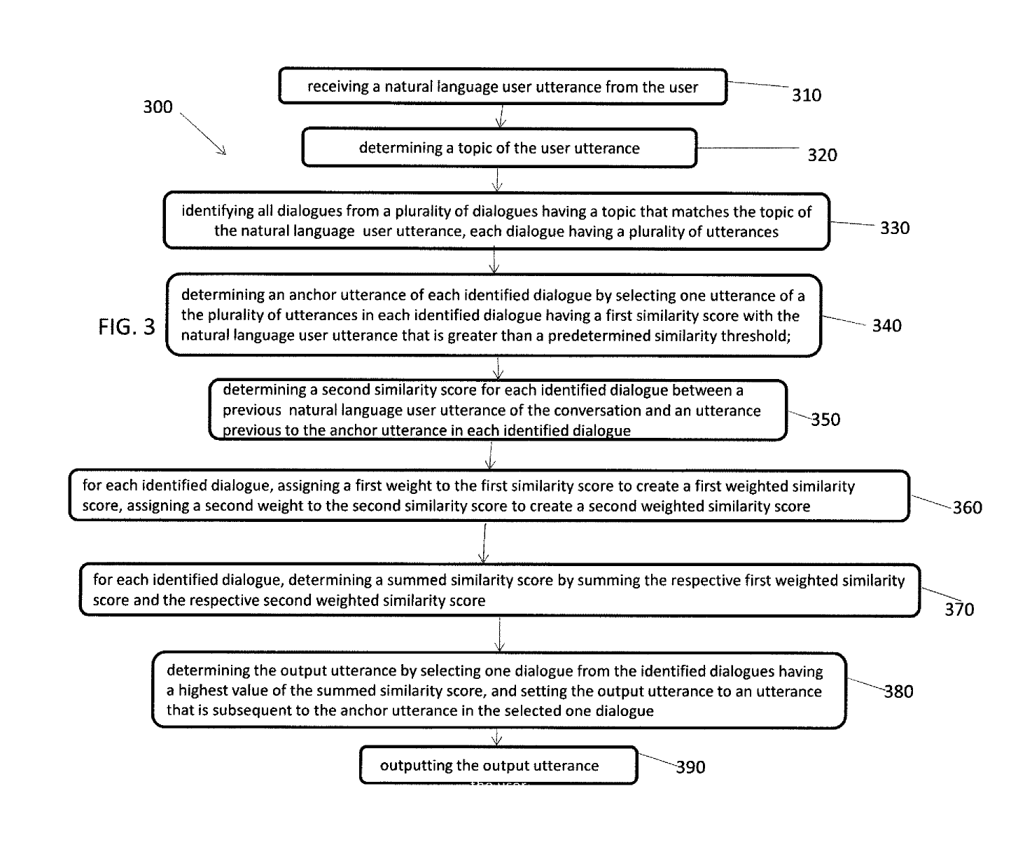

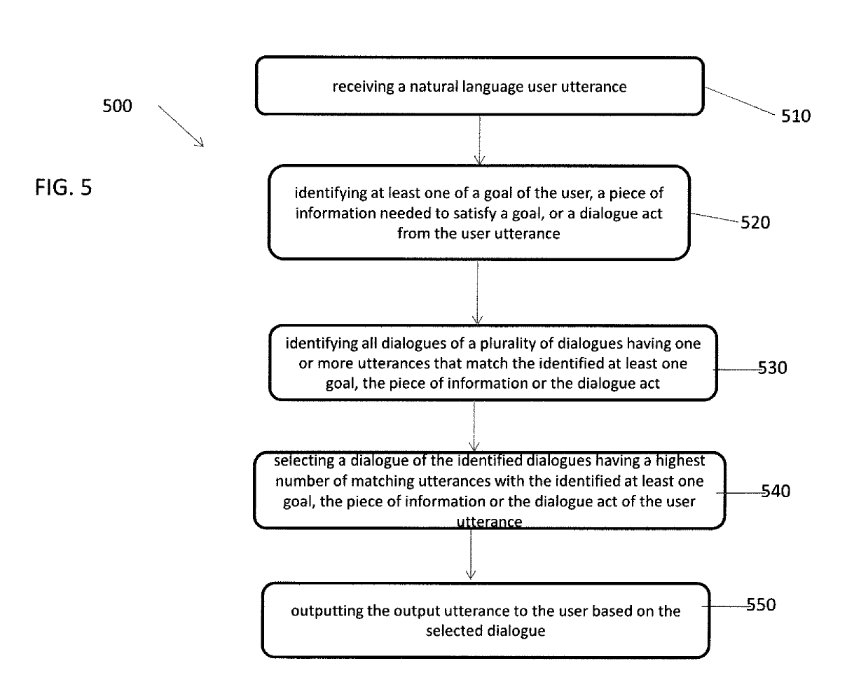

In various embodiments, the two or more conversational interfaces are dialogue management systems, question answering systems or any combination thereof. The dialogue management systems can include systems that operate in accordance with a data driven open domain dialogue management method as described below in FIG. 3, or a goal driven context method as described below in FIG. 5. In various embodiments, the dialogue management systems can include systems that operate in accordance with dialogue management methods as are known in the art. The question answering systems can include systems that operate in accordance with the frequently asked question method as described above with respect to FIG. 2, and Table 2. In various embodiments, the question answering system can include systems that operate in according with question answering methods as are known in the art.

The method can also involve selecting (e.g., by the arbitration module 110 as described above in FIG. 1) one candidate output utterance from all received candidate outputs based on a predetermined priority factor (Step 220). In various embodiments, the predetermined priority factor is based on the confidence factor, based on a type of the respective conversational interface, input by a user, based on the content of the utterance, or any combination thereof. For example, priority can be assigned to the conversational interface having the highest confidence factor. In another example, priority can be assigned by the user to a particular conversational interface of the two or more conversational interfaces.

In some embodiments, if the last conversational interface to respond to the user retains context of the dialogue, then the one candidate output is set to the output of the last conversational interface. In these embodiments, the predetermined priority factor can be ignored.

The method can also involve outputting the one candidate output utterance as the output utterance for the virtual agent (Step 230). The one candidate output utterance, the output utterance or both can be natural language.

FIG. 3 is a flow chart 300 of a method for generating an output utterance for a virtual agent's conversation with a user (e.g., by the data drive open domain dialogue module 115c as described above in FIG. 1), according to an illustrative embodiment of the invention. The output utterance can be used by a virtual agent or it can be a candidate output utterance, as described above with respect to FIG. 1 and FIG. 2.

The method can involve receiving a natural language utterance from the user (Step 310). In some embodiments, the utterances are received from a human user. In various embodiments, the user is another virtual agent, another computing system and/or any system that is capable producing utterances. The utterance can be received at any time during the dialogue with the virtual agent.

The method can involve determining a topic of the natural language user utterance (Step 320). The topic can be determined based on the natural language user utterance. For example, keywords within the natural language user utterance can be used to identify the topic.

In some embodiments, determining the topic of the utterance involves evaluating words in the utterance for frequency based on a corpus, and setting the topic to one of the words in the utterance based on the evaluation. For example, if an esoteric word appears in the utterance, it is very likely that it is the topic of the utterance. In various embodiments, determining the topic involves ignoring stop words and/or common verbs as possibilities for the topic.

In various embodiments, determining the topic of the utterance involves employing data driven topic modeling (e.g., modeling each utterance using Convolutional Neural Network (CNN) to a vector of features, vector similarity algorithms such as cosine similarity).

The method can involve identifying all dialogues from a plurality of dialogues having a topic that matches the topic of the natural language user utterance, each dialogue having a plurality of utterances (Step 330). The plurality of dialogues can be input by an administrative user. The plurality of dialogues can include dialogues that are based on actual dialogues that previously occurred between a virtual agent and a user, actual dialogues that previously occurred between a human agent and a user, dialogues created by an administrative user, dialogues as specified by a user (e.g., a company), or any combination thereof. Each of the plurality of dialogues can include any number of utterances from one to n, where n is an integer value. The plurality of dialogues can have varying utterance lengths. For example, a first dialogue of the plurality of dialogues can have 5 utterances, and a second dialogue of the plurality of dialogues can have 8 utterances.

In some embodiments, the topic of a dialogue can be determined based on data driven topic modeling (e.g., modeled using a Recurrent Neural Network (RNN)). In some embodiments, the topic of a dialogue is based on vector similarity algorithms.

The method can involve determining an anchor utterance of each identified dialogue by selecting one utterance of a the plurality of utterances in each identified dialogue having a first similarity score with the natural language user utterance that is greater than a predetermined similarity threshold (Step 340). In some embodiments, the plurality of utterances is an ordered list of utterances, and determining the anchor utterance involves i) determining a temporary similarity score between the natural language user utterance and each utterance in an order specified by the ordered list until the temporary similarity score is greater than the predetermined threshold; ii) setting the first similarity score to the temporary similarity score; and iii) setting the anchor utterance to the utterance having the temporary similarity score that is greater than the predetermined threshold.

Table 1 shows an example of a plurality of dialogues, and the anchor utterance for each where the predefined similarity threshold is 0.8.

TABLE 1

| Dialogue #1 | Dialogue #2 | Dialogue #3 |
|---|---|---|
| Utterance 1 | Utterance 1 | Utterance 1 |
| Similarity Score = 0.30 | Similarity Score = 0.25 | Similarity Score = |
| | | 0.93 |
| Utterance 2 | Utterance 2 | Utterance 2 |
| Similarity Score = 0.55 | Similarity Score = 0.32 | Similarity Score = |
| | | not determined |
| Utterance 3 | Utterance 3 | Utterance 3 |
| Similarity Score = 0.95 | Similarity Score = 0.38 | Similarity Score = |
| | | not determined |
| Utterance 4 | Utterance 4 | |
| Similarity Score = Not | Similarity Score = 0.50 | |
| determined | | |
| Utterance 5 | Utterance 5 | |
| Similarity Score = Not | Similarity Score = 0.75 | |
| determined | | |
| Utterance 6 | Utterance 6 | |
| Similarity Score = Not | Similarity Score = 0.91 | |
| determined | | |

As shown in Table 1, in this example Dialogue #1 has Utterance 3 with a similarity score of 0.95. Utterance 3 is the first utterance in Dialogue #1 to exceed the predetermined similarity threshold, thus, Utterance 3 is the anchor utterance, and the first similarity score for Dialogue #1 is 0.95. In this example Dialogue #2 has Utterance 6 with a similarity score of 0.91. Utterance 6 is the first utterance in Dialogue #2 to exceed the predetermined similarity threshold, thus, Utterance 6 is the anchor utterance, and the first similarity score for Dialogue #1 is 0.91. In this example Dialogue #3 has Utterance 1 with a similarity score of 0.93. Utterance 1 is the first utterance in Dialogue #3 to exceed the predetermined similarity threshold, thus, Utterance 1 is the anchor utterance, and the first similarity score for Dialogue #1 is 0.93.

The similarity score can be determined as described in further detail below with respect to FIG. 4. In some embodiments, the similarity score is determined as is known in the art.

In some embodiments, the predefined similarity threshold is based a desired level of similarity in the dialogue that is selected. In some embodiments, if there is no anchor utterance (e.g., no utterance in the dialogue having a similarity score that exceeds the predetermined similarity threshold), the dialogue is removed from the identified dialogues.

The method can involve determining a second similarity score for each identified dialogue between a previous natural language user utterance of the conversation and an utterance previous to the anchor utterance in each identified dialogue (Step 350). Continuing with the above example started in Table 1, for Dialogue #1, the second similarity score between a previous user utterance and Utterance 2 of Dialogue #1 is determined, the second similarity score between the previous user utterance and Utterance 5 of Dialogue #2 is determined, and the second similarity score between the previous user utterance and Utterance 1 of Dialogue #3 is determined. Note, for Dialogue #3, because there is not an utterance before the anchor utterance, the anchor utterance is used in determining the second similarity score.

The method can involve for each identified dialogue, assigning a first weight to the first similarity score to create a first weighted similarity score, assigning a second weight to the second similarity score to create a second weighted similarity score (Step 360). In some embodiments, the first weight is based on the second weight. In some embodiments, the first weight and/or the second weight are based on a predetermined factor.

The method can involve for each identified dialogue, determining a summed similarity score by summing the respective first weighted similarity score and the respective second weighted similarity score (Step 370).

In some embodiments, for each identified dialogue, a similarity score is identified between the anchor utterance (Un) and each utterance coming before the anchor utterance (Un−i) in the dialogue, where i is an integer value from 1 to the number of utterances coming before the anchor utterance. In these embodiments, each similarity score can be weighted and summed to determine the summed similarity score.

In some embodiments, the weights and the summed similarity score (S) are determined as shown below in EQN. 1 and EQN 2.

S=dw₀U₀+dw₁U_{1+ . . . +}dwₙUₙ EQN. 1

w₁=d*w₀, w₂=d*w_{1, . . .} wₙ=d*wₙ₋₁ EQN. 2

where w is the weight, U is the similarity score between the anchor utterance and a particular utterance I the dialogue, and d is the predetermined factor. The predetermined factor can be based on the domain and/or the dialogue type (e.g., chit chat). In some embodiments, the predetermined factor is based on a desired level of contextual similarity. The predetermined factor can be based on a desired level of accuracy in an answer versus an ability to provide an answer.

The method can involve determining the output utterance by selecting one dialogue from the identified dialogues having a highest value of the summed similarity score, and setting the output utterance to an utterance that is subsequent to the anchor utterance in the selected one dialogue (Step 380). In this manner, in some embodiments, a dialogue of the plurality of dialogues having a high level of similarity with the dialogue between the virtual agent and the use can be identified.

The method can involve outputting the output utterance to the user (Step 390). The output utterance can be a natural language response to the user. The output can be via an avatar on a computer screen, a text message, a chat message, or any other mechanism as is known in the art to output information to a user.

FIG. 4 is a flow chart 400 of a method for a virtual agent to determine a similarity (e.g., the similarity scores as described above with respect to FIG. 3 and/or by the similarity module 120 as described above in FIG. 1) between a first utterance and a second utterance, according to an illustrative embodiment of the invention.

The method can involve receiving the first utterance and the second utterance (Step 410). The first utterance and/or the second utterance can be natural language. The first utterance can be an utterance input by a user and the second utterance can be a predetermined utterance (e.g., an utterance in one or more stored dialogues as described above with respect to FIG. 3).

The method can also involve determining one or more cardinalities between one or more respective intersections of the first utterance and the second utterance (Step 420). In some embodiments, the method involves determining eight cardinalities as follows:
1. determining a first cardinality of a first intersection of the first utterance and the second utterance;
2. determining a second cardinality of a second intersection of trigrams of the first utterance and trigrams of the second utterance;
3. determining a third cardinality of a third intersection of bigrams of the first utterance and bigrams of the second utterance;
4. determining a fourth cardinality of a fourth intersection of word lemmas of the first utterance and word lemmas of the second utterance;
5. determining a fifth cardinality of a fifth intersection of word stems of the first utterance and word stems of the second utterance;
6. determining a sixth cardinality of a sixth intersection of skip grams of the first utterance and skip grams of the second utterance;
7. determining a seventh cardinality of a seventh intersection of word2vec of the first utterance and word2vec of the second utterance; and
8. determining an eighth cardinality of an eighth intersection of antonyms of the first utterance and antonyms of the second utterance.

The method can also involve determining the similarity score based on a weighted sum of the one or more cardinalities (Step 430). In the embodiments where eight cardinalities are determined, the similarity score can be determined based on a weighted sum of the first cardinality, the second cardinality, the third cardinality, the fourth cardinality, the fifth cardinality, the sixth cardinality, the seventh cardinality and the eighth cardinality, wherein the weights are predetermined weights. The similarity score can be determined as shown below in EQN. 3.

$$YAT score ( {U}_{1} , {U}_{2} ) = {a}_{1} \cdot \vert {U}_{1} ⋂ {U}_{2} \vert + {a}_{2} \cdot \vert trigrams ( {U}_{1} ) ⋂ trigrams ( {U}_{2} ) \vert + {a}_{3} \cdot \vert bigrams ( {U}_{1} ) ⋂ \text{bigrams} ( {U}_{2} ) \vert + {a}_{4} \cdot \vert lemmas ( {U}_{1} ) ⋂ lemmas ( {U}_{2} ) \vert + {a}_{5} \cdot \vert stems ( {U}_{1} ) ⋂ stems ( {U}_{2} ) \vert + {a}_{6} \cdot \vert skipgrams ( {U}_{1} ) ⋂ skipgrams ( {U}_{2} ) \vert + {a}_{7} \cdot w 2 {v}_{similarity} + {a}_{8} \cdot ( \vert antonyms ( {U}_{1} ) ⋂ {U}_{2} \vert + \vert antonyms ( {U}_{2} ) ⋂ {U}_{1} \vert ) \qquad EQN . 3$$

where |.| indicates cardinality, U₁ is the first utterance, U₂ is the second utterance, and a₁ through a₈ are weights (e.g., −1≤aᵢ≤1). In some embodiments, the weights aᵢ are based on a paraphrase corpus and multivariate regression.

In some embodiments, the first utterance is a frequently asked question. In these embodiments, similarity between the first utterance and one or more predetermined utterances (e.g., one or more stored frequently asked questions, each having a corresponding answer) is determined, and the predetermined utterance of the one or more predetermined utterances having the highest similarity is chosen as matching the first utterance (e.g., the frequently asked question). The answer that corresponds to the chosen predetermined utterance can be output the user.

In some embodiments, the similarity score is determined to rank similarity of the first utterance against adjacency pairs (e.g., via the FAQ module 115a as described above in FIG. 1). For example, Table 2 shows a frequently asked question adjacency pair template.

```
TABLE 2
    <AdjacencyPairs>
      <AdjacencyPair uuid=“d3a51391-5039-479f-8094-2ef5ea27dbf4”>
        <questions>
          <question> Why do I need to add my spouse or domestic partner if he/she
has other insurance? </questions>
          <question> My wife has her own insurance why do I need to add her?
</question>
          <question> My husband has already a car insurance why do I need to put
him to my policy? </question>
        </questions>
        <answer>
          Due to potential coverage implications, we require that spouses and
domestic partners be listed on auto policies.
        </answer>
      </AdjacencyPair>
      <AdjacencyPair uuid=“68e42c14-a190-4f7d-9dba-e159754b0621”>
        <questions>
          <question> What rights does another interested party have?</question>
          <question> Can you tell me the rights of another interested
party?</question>
        </questions>
        <answer>
          Other interested parties have no insurable interest in the vehicle, but
are entitled to certain notifications, including policy coverage changes, cancellation, and/or
reinstatement, and the vehicle to which the interest has been written is added or deleted.
        </answer>
      </AdjacencyPair>
    </AdjacencyPairs>
```

If the utterance input by the user is “do I have to add my wife to my car insurance,” a similarity between the utterance input and each question in Table 2 will be determined, and the answer corresponding to the question in the Table 2 having the highest similarity with the utterance input is output. The similarity can be determined as described above.

The method can also involve outputting the similarity score (Step 440). The similarity score can be output to one or more conversational interfaces (e.g., as shown above in FIG. 1).

FIG. 5 is a flow chart of a method 500 for generating an output utterance for a virtual agent's conversation with a user (e.g. by the goal driven context module 115b as described above in FIG. 1), according to an illustrative embodiment of the invention. The output utterance can be used by a virtual agent or it can be a candidate output utterance, as described above with respect to FIG. 1 and FIG. 2.

The method can involve receiving a natural language user utterance (Step 510). The method can also involve identifying at least one of a goal of the user, a piece of information needed to satisfy a goal (e.g., slot), or a dialogue act from the user utterance (Step 520). The utterance can be determined to be a goal, slot and/or dialogue act by parsing the utterance and/or recognizing the intent of the utterance. The parsing can be based on identifying patterns in the utterance by comparing the utterance to pre-defined patterns. In some embodiments, parsing the utterance can be based on context free grammars, text classifiers and/or language understanding methods as is known in the art.

The method can also involve identifying all dialogues of a plurality of dialogues having one or more utterances that match the identified at least one goal, the piece of information or the dialogue act (Step 530). Each dialogue in the plurality of dialogues can be annotated with one or more slots, goals and dialogue acts. The match can be based on the annotations in the plurality of dialogues. In some embodiments, the dialogue having the greatest number of matches with the identified at least one goal is selected as the match.

The method can also involve selecting a dialogue of the identified dialogues having a highest number of matching utterances with the identified at least one goal, the piece of information or the dialogue act of the user utterance (Step 540).

The method can also involve outputting the output utterance to the user based on the selected dialogue (Step 550).

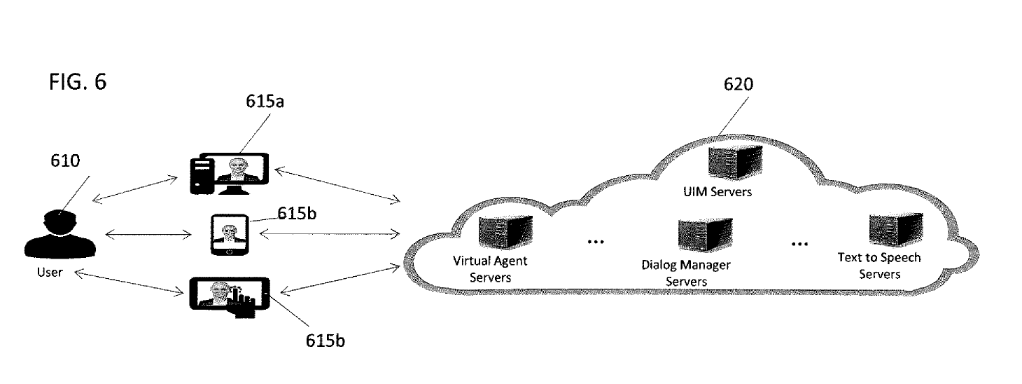

FIG. 6 is a diagram of a system 620 for a virtual agent, according to an illustrative embodiment of the invention. A user 610 can use a computer 615a, a smart phone 615b and/or a tablet 615c to communicate with a virtual agent. The virtual agent can be implemented via system 620. The system 620 can include one or more servers to, for example, handle dialogue management, question answer conversations, store data, etc. . . . Each server in the system 620 can be implemented on one computing device or multiple computing devices. As is apparent to one of ordinary skill in the art, the system 620 is for example purposes only and that other server configurations can be used (e.g., the virtual agent server and the dialogue manager server can be combined).

The above-described methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., MICROSOFT® INTERNET EXPLORER® available from Microsoft Corporation, Chrome available from Google, MOZILLA® Firefox available from Mozilla Corporation, Safari available from Apple). A mobile computing device can include, for example, a personal digital assistant (PDA).

Website and/or web pages can be provided, for example, through a network (e.g., Internet) using a web server. The web server can be, for example, a computer with a server module (e.g., MICROSOFT® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, BLUETOOTH®, code-division multiple access (CDMA) network, time division multiple access (TDMA) network, global system for mobile communications (GSM) network), and/or other circuit-based networks.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes. Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A computerized method for generating an output utterance for a virtual agent's conversation with a user, the method comprising:
receiving a natural language user utterance from the user;
determining a topic of the natural language user utterance;
identifying all dialogues from a plurality of dialogues having a topic that matches the topic of the natural language user utterance, each dialogue having a plurality of utterances;
determining an anchor utterance of each identified dialogue by selecting one utterance of the plurality of utterances in each identified dialogue having a first similarity score with the natural language user utterance that is greater than a predetermined similarity threshold;
determining a second similarity score for each identified dialogue between a previous natural language user utterance of the conversation and an utterance previous to the anchor utterance in each identified dialogue;
for each identified dialogue, assigning a first weight to the first similarity score to create a first weighted similarity score, assigning a second weight to the second similarity score to create a second weighted similarity score;
for each identified dialogue, determining a summed similarity score by summing the respective first weighted similarity score and the respective second weighted similarity score;
determining the output utterance by selecting one dialogue from the identified dialogues having a highest value of the summed similarity score, and setting the output utterance to an utterance that is subsequent to the anchor utterance in the selected one dialogue; and
outputting the output utterance to the user.

2. The computerized method of claim 1, wherein the plurality of utterances is an ordered list of utterances and determining the anchor utterance further comprises:
determining a temporary similarity score between the natural language user utterance and each utterance in an order specified by the ordered list until the temporary similarity score is greater than the predetermined threshold;
setting the first similarity score to the temporary similarity score; and
setting the anchor utterance to the utterance having the temporary similarity score that is greater than the predetermined threshold.

3. The computerized method of claim 1, wherein the output utterance is natural language.

4. The computerized method of claim 1, wherein determined the first similarity score further comprises:
for each of the plurality of utterances compared against the user utterance, determining one or more cardinalities between one or more respective intersections of the current utterance of the plurality of utterances and the user utterance; and
determining the first similarity score based on a weighted sum of the one or more cardinalities.

5. The computerized method of claim 1, wherein determining the second similarity score further comprises:
determining one or more cardinalities between one or more respective intersections of the previous user utterance and the utterance previous to the anchor utterance; and
determining the second similarity score based on a weighted sum of the one or more cardinalities.

6. The computerized method of claim 1, wherein the predetermined similarity threshold is input by a user or based on a topic of conversation.

7. A computerized method for automatically determining an output utterance for a virtual agent based on output of two or more conversational interfaces, the method comprising:
receiving a candidate output utterance from each of the two or more conversational interfaces, wherein the candidate output utterance is a statement;
selecting one candidate output utterance from all received candidate outputs based on a predetermined priority factor; and
outputting as text or speech the one candidate output utterance as the output for the virtual agent to output to a user.

8. The computerized method of claim 7, wherein the two or more conversational interfaces are a data driven dialogue management system and a question answering system.

9. The computerized method of claim 7, further comprising:
receiving a corresponding confidence factor with each candidate output utterance from each of the two or more conversational interfaces, and wherein selecting the one candidate output utterance is further based on the corresponding confidence factor, wherein the confidence factor indicates a confidence of the respective conversational interface in its produced candidate output utterance.

10. The computerized method of claim 7, wherein the predetermined priority factor is based on a confidence factor, a type of the respective conversational interface, input by a user, based on the content of the utterance, or any combination thereof.

11. The computerized method of claim 7, wherein selecting one candidate output utterance is further based on:
determining one conversational interface of the two or more conversational interfaces that output a previous output utterance; and
if the one conversational interface that output the previous utterance retains context of dialogues, then the corresponding candidate output utterance of the one conversational interface that retains context of dialogues is set as the one candidate output utterance otherwise, the one candidate output utterance continues to be based on the predetermined priority factor.

12. The computerized method of claim 7, wherein each of the two or more conversations interfaces processes a different conversation type.

13. The computerized method of claim 7, wherein the candidate output utterance, the output utterance, or both are natural language.

14. A computerized method for generating an output utterance for a virtual agent's conversation with a user, the method comprising:
receiving a natural language user utterance;
identifying at least one of a goal of the user, a piece of information needed to satisfy a goal, or a dialogue act from the user utterance;
identifying all dialogues of a plurality of dialogues that match the identified at least one goal, the piece of information or the dialogue act;
selecting a dialogue of the identified dialogues having a highest number of matching utterances with the identified at least one goal, the piece of information or the dialogue act of the user utterance; and
outputting the output utterance to the user based on the selected dialogue.

15. The computerized method of claim 14, wherein, if more than one dialogue is identified as having a highest number of matches with the identified at least one goal, the piece of information or the dialogue act of the user utterance, selecting one of the more than one dialogues.

16. The computerized method of claim 14, wherein the output utterance is natural language.

17. The computerized method of claim 7 wherein each of the two or more conversational interfaces is a data-driven dialogue system.
